(19) United States
(12) Patent Application Publication
(10) Pub. No.: US 2006/0132820 A1
(43) Pub. Date: Jun. 22, 2006

(54) Image processing apparatus configured to obtain electronic data stored in storage by reading image document and method for the same

(75) Inventor: Naohiro Isshiki, Kawasaki-shi (JP)

Correspondence Address: Canon U.S.A. Inc.;Intellectual Property Division, 15975 Alton Parkway, Irvine, CA, 92618-3731, US

(73) Assignee: Canon Kabushiki Kaisha, Ohta-ku (JP)

(21) Appl. No.: 11/300,092

(22) Filed: Dec. 14, 2005

(30) Foreign Application Priority Data
Dec. 16, 2004 (JP) 2004-364780

(51) Int. Cl. G06F 3/12

(52) U.S. Cl. 358/1.13

(57) ABSTRACT

A image processing apparatus is capable of easily printing a predetermined range of electronic data that is stored in a storage and retrieved by the apparatus by carrying out a process of reading a document, detecting storage information from the image data corresponding to the read document, and retrieving electronic data corresponding to the document from a storage in the apparatus or a device connected to a network on the basis of the storage information. Moreover, the if electronic data corresponding to a document exists and the document is a part of the electronic data, a printing mode is selected, and then the electronic data is printed out in accordance with the printing mode. In this way, a predetermined range of the electronic data that does not degrade can be easily printed out.

### BACKGROUND OF THE INVENTION

1. Field of the Invention

The present invention relates to an image processing apparatus and a method for the same, and more specifically, relates to an image processing apparatus capable of utilizing electronic data of an image of a document stored in a storage and a method for the same.

2. Description of the Related Art

A digital copying apparatus optically scans a document to obtain an image, converts the scanned image into an electronic image, and prints out a copy of the document based on the electronic image. However, when using such a digital copying technique to copy all pages of a document including a plurality of pages, there are typically three major problems: 1) copies of all pages of the document cannot be obtained when any of the pages of the document to be copied are missing; 2) every page of the document has to be copied page by page unless an automatic document feeder is available for automatically scanning the plurality of pages; and 3) the quality of the copied images is degraded when copies of the copied documents are produced.

To solve such problems, for example, Japanese Patent Laid-Open No. 10-308868 (corresponding to U.S. patent application publication No. 2001-0029513 A1) describes a system capable of printing out a document by storing electronic data corresponding to images of a document, reading a document ID attached to the document, and printing out the electronic data corresponding to the document ID.

However, the system described in Japanese Patent Laid-Open No. 10-308868 prints out all the pages included in the electronic data retrieved on the basis of the document ID. In other words, it is difficult to obtain a desired part of the electronic data specified by the document ID.

### SUMMARY OF THE INVENTION

A feature of the present invention provides an image process apparatus and a method for the same that are capable of solving the above-identified problems.

Another feature of the present invention provides an image process apparatus and a method for the same that are capable of facilitating the processing of electronic data being stored in a storage and corresponding to a document.

Another feature of the present invention provides an image process apparatus and a method for the same that are capable retrieving a portion of electronic data stored in a storage without complicated operations.

Further features of the present invention will become apparent from the following description of exemplary embodiments (with reference to the attached drawings).

An embodiment of the present invention provides an image processing apparatus including a reading unit adapted to read at least a page of a document and to generate image data corresponding to the read page, a detecting unit adapted to detect specifying information included in the image data obtained by the reading unit, wherein the specifying information includes information on electronic data corresponding to the document read by the reading unit, a searching unit adapted to retrieve the electronic data from a storage on the basis of the specifying information detected by the detecting unit, a setting unit adapted to set a printing mode of the electronic data retrieved by the searching unit when the page read by the reading unit corresponds to a portion of the document corresponding to the retrieved electronic data, and a printing unit adapted to print out an image of the retrieved electronic data in accordance with the printing mode set by the setting unit.

Another embodiment of the present invention provides an image processing method comprising the steps of reading at least a page of a document and to generate image data corresponding to the read page, detecting specifying information included in the image data obtained by the reading unit, wherein the specifying information including information on electronic data corresponds to the document read by the reading unit, retrieving the electronic data from a storage on the basis of the specifying information detected by the detecting unit, setting a printing mode of the electronic data retrieved by the searching unit when the page read by the reading unit corresponds to a portion of the document corresponding to the retrieved electronic data, and printing out an image of the retrieved electronic data in accordance with the printing mode set by the setting unit.

Further features of the present invention will become apparent from the following description of exemplary embodiments (with reference to the attached drawings).

### BRIEF DESCRIPTION OF THE DRAWINGS

FIG. 1 is a block diagram of an exemplary architecture of a printing system according to an embodiment of the present invention.

FIG. 2 illustrates an exemplary software configuration of the printing system shown in FIG. 1.

FIG. 3 is a flow chart showing an exemplary operation of a printing apparatus or a multi-function apparatus when the apparatus receives data.

FIG. 4 is a flow chart showing an exemplary printing process in detail.

FIG. 5 is a flow chart showing an exemplary storage search process in detail.

FIG. 6 is a flow chart showing an exemplary storage process in detail.

FIG. 7 illustrates an exemplary packet configuration for storage search.

FIG. 8 illustrates an exemplary packet configuration for storage search results.

FIG. 9 illustrates an exemplary packet configuration for data storage.

FIG. 10 illustrates an exemplary packet configuration for data retrieval request.

FIG. 11 illustrates an exemplary packet configuration for data transfer of the retrieved data.

FIG. 12 is a flow chart showing an exemplary copying process carried out by a multi-function apparatus.

FIG. 13 is an exemplary operation screen.

FIG. 14 is an exemplary flow chart showing a printing process for printing the pages interposed between two predetermined pages.

FIG. 15 is a flow chart showing an exemplary data retrieval process.

FIG. 16 is a flow chart showing an exemplary process of assigning a printing mode by a user before starting the copying process.

FIG. 17 is an exemplary operation screen.

### DESCRIPTION OF THE EMBODIMENTS

Several embodiments, features and aspects of the present invention will be now herein be described in detail below with reference to the drawings.

### First Exemplary Embodiment

[Exemplary Hardware Configuration]

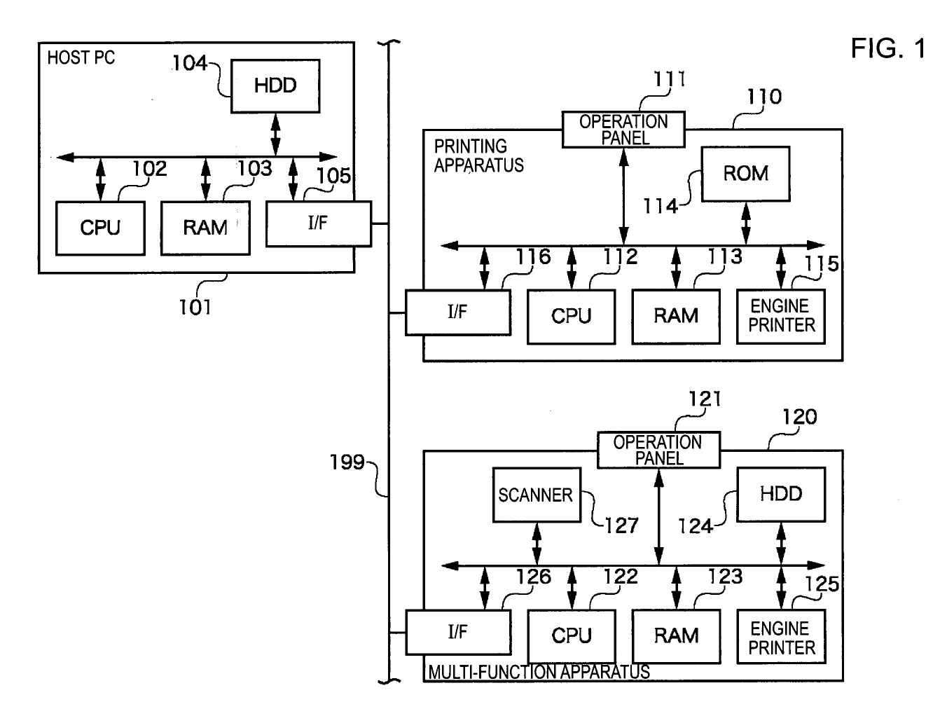

FIG. 1 is block diagram showing the structure of a printing system according to a first embodiment. A host computer (referred to as a host PC) 101, a printing apparatus 110, and a multi-function apparatus 120, all connected to a network 199, are capable of communicating with each other via the network 199.

A central processing unit (CPU) 102 of the host PC 101 uses a random access memory (RAM) 103 as a work memory to execute software stored in a hard disk drive (HDD) 104 or the like. In the HDD 104, an operating system (OS), application software, application data, and other data are stored. The CPU 102 is capable of communicating with devices connected to the network 199 via a communication interface (I/F) 105.

A CPU 112 of the printing apparatus 110 uses a RAM 113 as a work memory to execute software stored in the ROM 114 and operates the printing apparatus 110 in accordance with instructions input via an operation panel 111 by a user. The CPU 112 generates image data based on page description language (PDL) data input from external devices connected via a communication I/F 116 and supplies this image data to a printer engine 115 for printing on a sheet of recording paper.

A CPU 122 of the multi-function apparatus 120 uses a RAM 123 as a work memory to execute software stored in an HDD 124 and operates the multi-function apparatus 120 in accordance with instructions input via an operation panel 121 by the user. A page of a document is copied onto a sheet of recording paper by reading the page with a scanner 127 to generate image data and sending the generated image data to a printer engine 125. The scanner 127 includes an automatic document feeder (ADF) configured to convey the pages of a document and enable continuous scanning. The HDD 124 is capable of storing PDL data, intermediate language data, and image data. The CPU 122 generates image data based on the PDL data input from an external device via the communication I/F 126. Then, the CPU 122 sends the generated image data to the printer engine 125 for printing on a sheet of recording paper. The image data obtained by reading a page of a document by the scanner 127 can be sent to external devices via the communication I/F 126.

[Exemplary Software Configuration]

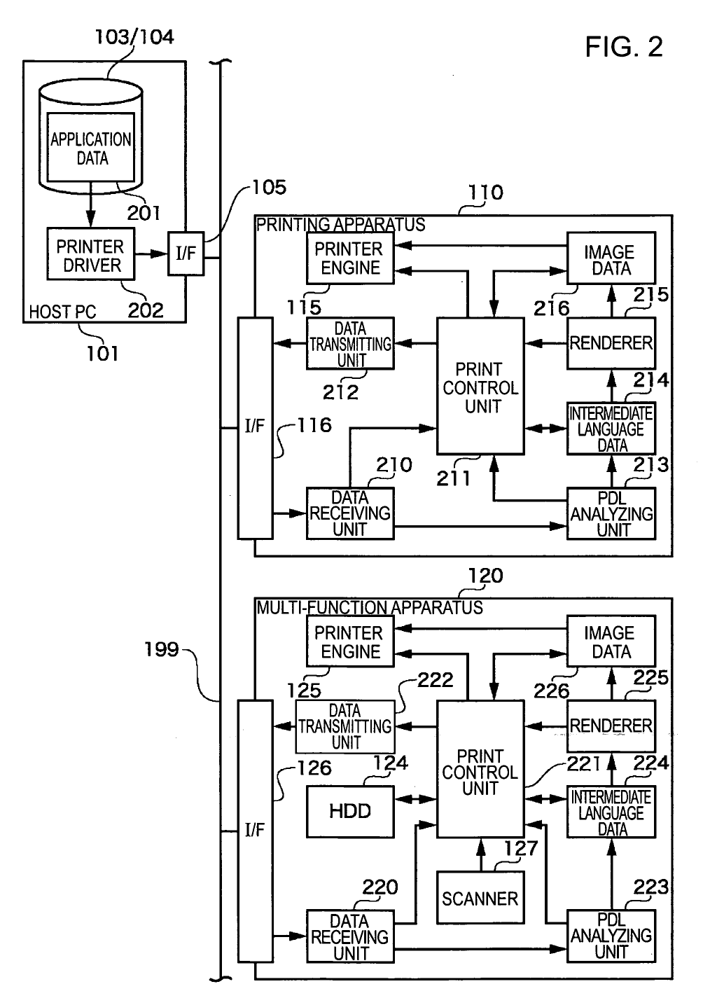

FIG. 2 illustrates an exemplary software configuration of the printing system according to this embodiment. In the host PC 101, when an instruction to execute the print function is sent from the application software, a printer driver 202 is called up. The printer driver 202 displays a print setting screen (user interface) for printing application data 201 stored in the RAM 103 or the HDD 104. Then, the printer driver 202 generates PDL data in accordance with an instruction input by the user via the print setting screen and transmits the PDL data to a device connected to the network 199 via the I/F 105.

In the printing apparatus 110, a data receiving unit 210 analyzes the data received from the network 199 via the I/F 116 and determines the destination of the received data on the basis of the result of the analysis. A print control unit 211 is provided for print control. A data transmitting unit 212 transmits an enquiry to other devices connected to the network 199 based on the control by the print control unit 211. A PDL analyzing unit 213 analyzes the received PDL data so as to generate intermediate language data 214. A renderer 215 renders the intermediate language data 214 so as to generate image data 216. Also, a printer engine 115 is provided which is in communication with the print control unit 211 and of which is configured to receive image data 215.

The exemplary multi-function apparatus 120 has a similar architecture as that of the printing apparatus 110; therefore, descriptions thereof are omitted.

[Exemplary Processing]

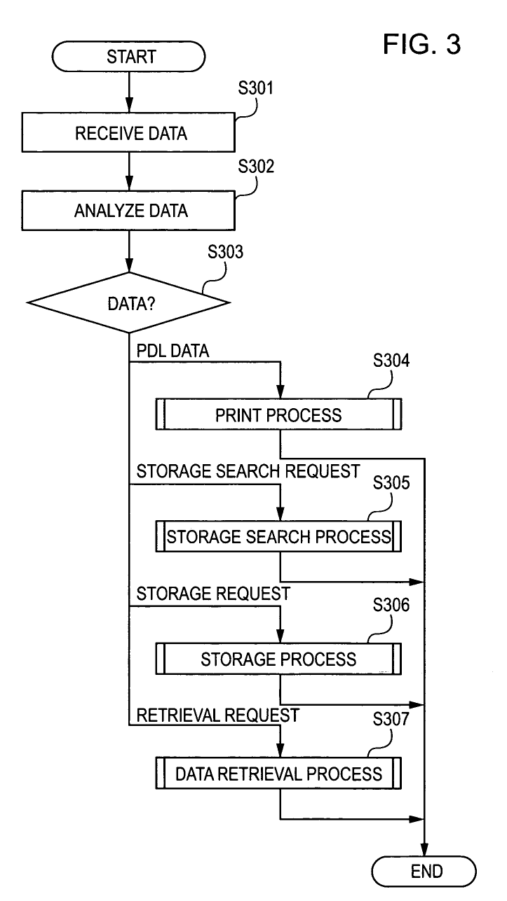

FIG. 3 is a flow chart showing an exemplary operation of the printing apparatus 110 or the multi-function apparatus 120 when receiving data from the network 199. The printing apparatus 110 (multi-function apparatus 120) receives data from the network 199 (S301), the received data is analyzed at the data receiving unit 210 (220), and then the result of determining the type of the received data is sent to the print control unit 211 (221) (S302).

The print control unit 211 (221) switches the operation in accordance with the type of the received data (S303). When PDL data is received, a printing process is carried out (S304). When a storage search request is received, a storage search process (a process of searching a storage for storing print data in a form that is later retrievable) is carried out (S305). When a storage request is received, a storage process (a process of storing print data in a storage) is carried out (S306). When a retrieval request is received, a data retrieval process (a process of retrieving print data stored in a storage) is carried out (S307).

[Exemplary Printing Process]

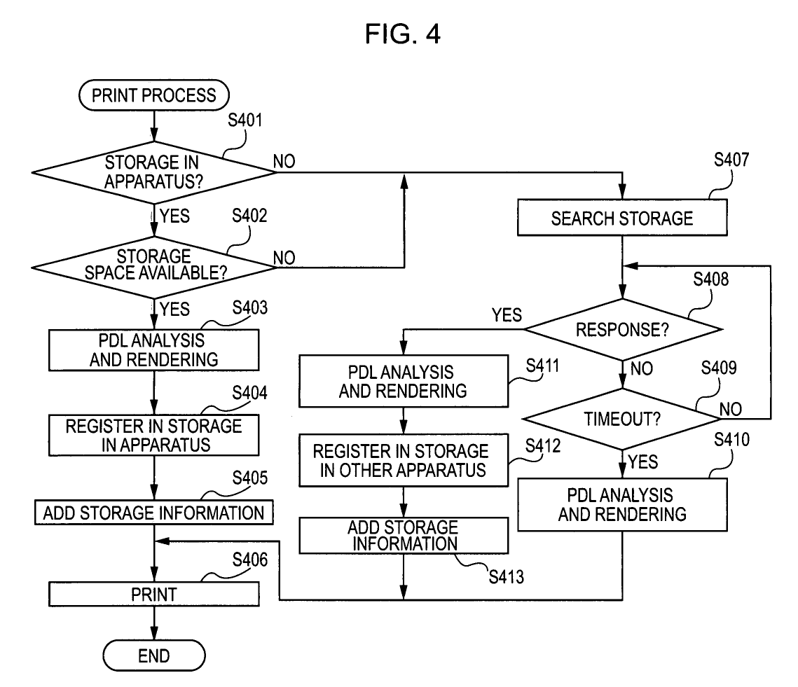

FIG. 4 is a flow chart showing exemplary details of the printing process (S304). The print control unit 211 (221) determines whether there is storage within the printing apparatus 110 (or the multi-function apparatus 120) (S401). In case of the multi-function apparatus 120, the print control unit 221 determines that there is storage since the HDD 124 is provided, whereas, in case of the printing apparatus 110, the print control unit 211 determines that there is no storage.

When there is storage, the print control unit 221 determines whether space is available in the storage (S402). When space is available, PDL analyzing unit 223 analyzes the received PDL data so as to generate intermediate language data 224 for each page of the document, and renderer 225 renders the intermediate language data 224 so as to generate image data 226 by rendering the PDL analyzing unit 223 (S403).

The print control unit 221 stores the intermediate language data 224 or the image data 226 for each of the pages as a data file in a storage (HDD 124) (S404). The name of the file generated at this time may be “apparatus ID_document ID_page number.” All pages included in one PDL data set make up a single document, wherein the document ID is a unique document identifier provided by the print control unit 221.

The print control unit 221 adds a file name, which is storage information indicating the storage location of the intermediate language data 224 or the image data 226, and an address of the apparatus (for example, an IP address or a MAC address) to the image data 226 (S405). The image data 226 is sent to the printer engine 125 for printing (S406). The storage information may be included in the header or footer of the printed document as a character string of a two-dimensional bar code or may be embedded in the printed document as an electronic watermark.

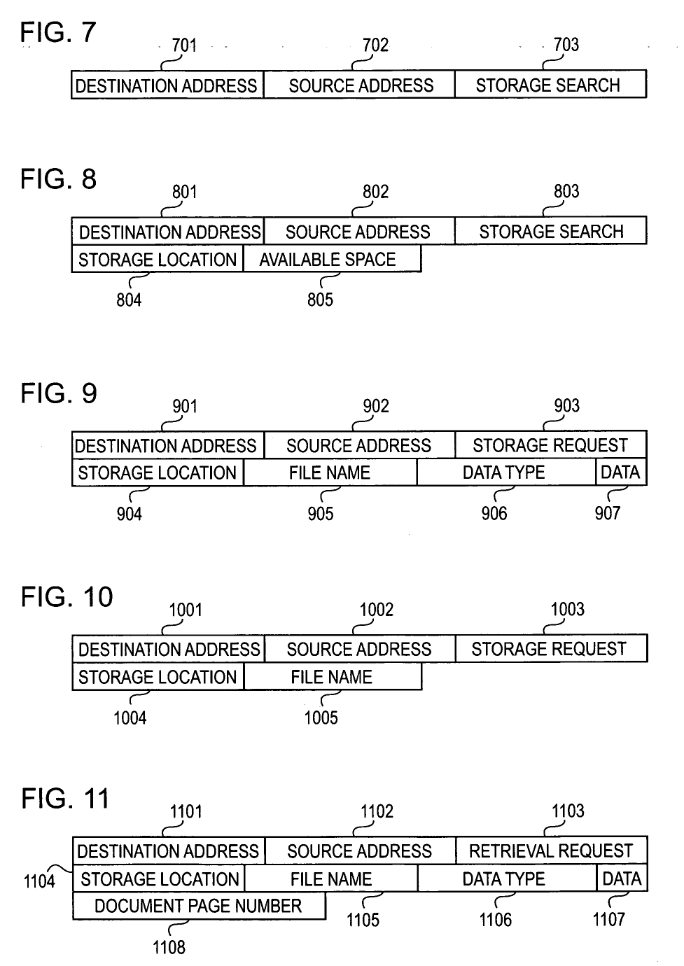

When the apparatus does not include storage or when there is no space available in the storage included in the apparatus, the print control unit 211 (221) searches for a storage in other devices connected to the network 199 (S407). The storage search process is carried out by the data transmitting unit 212 (222) by broadcasting packets, as shown in FIG. 7, to the network 199. In FIG. 7, a code corresponding to a broadcast address is written in a destination address field 701, a code corresponding to the address of the apparatus is written in a source address field 702, and a code corresponding to ‘storage search’ is written in a command field 703.

After packets for storage search are broadcasted, the print control unit 211 (221) waits for a response (S408) or timeout (S409). If a device having a storage with available space is connected to the network 199, a packet, as shown in FIG. 8, is sent back as a response. In FIG. 8, a code corresponding to the address of the apparatus that has requested the storage search is written in a destination address field 801, a code corresponding to the address of the device that has responded to the storage search is written in a source address field 802, and a code corresponding to ‘storage search result’ is written in a command field 803. After the command field 803, a code corresponding to information indicating the storage location is written in a storage location field 804, and a code corresponding to the size of the storage area available is written in a storage size field 805. For example, in a response packet from a WINDOWS machine, the source address 802 includes an IP address, and the storage location field 804 includes a drive name, such as ‘C.’

When the packet for the storage search result, shown in FIG. 8, is received, the print control unit 211 (221) generates the intermediate language data 224 for each page of the document by analyzing the received PDL data by the PDL analyzing unit 213 (223). Then, the renderer 215 (225) renders the intermediate language data 214 (224) to generate the image data 216 (226) (S411).

Then, the print control unit 211 (221) stores the intermediate language data 224 or the image data 226 for each of the pages of the document as a data file in the retrieved storage (S412). At this time, the intermediate language data 224 or the image data 226 is transmitted as the packets shown in FIG. 9. As shown in FIG. 9, a code corresponding to the address written in the source address field 802 of the packet shown in FIG. 8 is written in a destination address field 901, a code corresponding to an address of the apparatus is written in a source address field 902, and a code corresponding to ‘storage request’ is written in a command field 903. Furthermore, a code corresponding to the storage location in the storage location field 804 is written in a storage location field 904, a code corresponding to the file name for the file is written in a file name field 905, and a code corresponding to data type (i.e., information indicating, for example, intermediate language data or image data) is written in a data type field 906. A data field 907 includes the actual data.

The data length of the fields 904 to 907 may be fixed. However, an additional data length field indicating the data length value included in the data length field 907 may be provided so that the data length field 907 may have a variable data length. The name of the file generated at this time may be named “apparatus ID_document ID_page number.”

Then, the print control unit 211 (221) adds storage information indicating the storage location of the intermediate language data 214 (224) or the image data 216 (226). In other words, the address of the device providing the storage, the storage location, and the file name (which are equivalent to the codes written in the destination address field 901, the storage location field 904, and the file name field 905, respectively, as shown in FIG. 9) are added to the image data 216 (226) (S413). Then, this image data 216 (226) is sent to the printer engine 115 (125) for printing (S406).

If the storage search is timed out, the print control unit 211 (221) determines that no available storage space is connected to the network 199. Then, the PDL analyzing unit 213 (223) analyzes the received PDL data to generate intermediate language data 214 (224). Subsequently, the renderer 215 (225) renders the intermediate language data 214 (224) to generate the image data 216 (226) (S410) and supplies this image data 216 (226) to the printer engine 115 (125) to print out the image data 216 (226) (S406).

[Exemplary Storage Search Process]

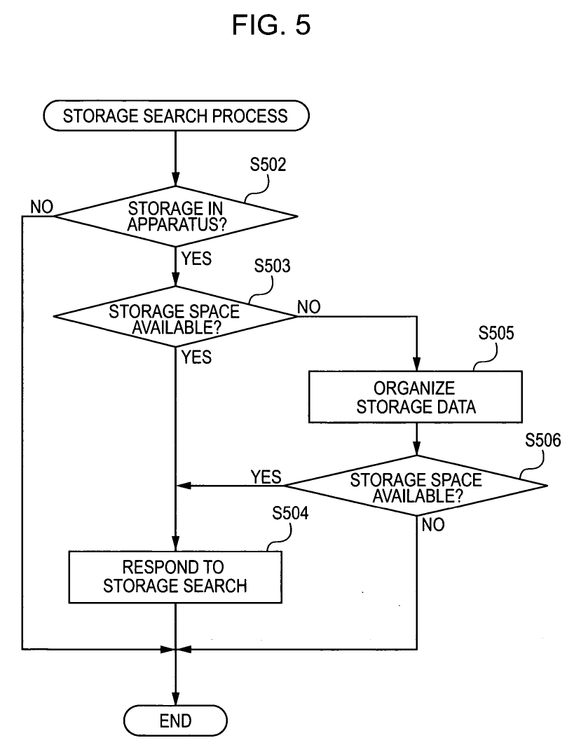

FIG. 5 is a flow chart showing exemplary details of the storage search process (S305). The print control unit 211 (221) determines whether storage is available in the apparatus (S502). In case of the printing apparatus 110, the process is ended since the printing apparatus 110 does not include a storage, whereas, in the case of the multi-function apparatus 120, the print control unit 211 (221) determines that storage is available and then determines whether storage space is available in the HDD 124 (S503). If storage space is available, the packet shown in FIG. 8 is sent back as a response (S504). If there is not storage space available, the data stored in the HDD 124 is organized in an attempt to create storage space (S505), and then the HDD 124 is checked again to determine whether storage space is available (S506). If it is determined that storage space is available, the packet shown in FIG. 8 is sent back as a response (S504). If it is determined that not storage space is available, the process is ended.

[Exemplary Storage Process]

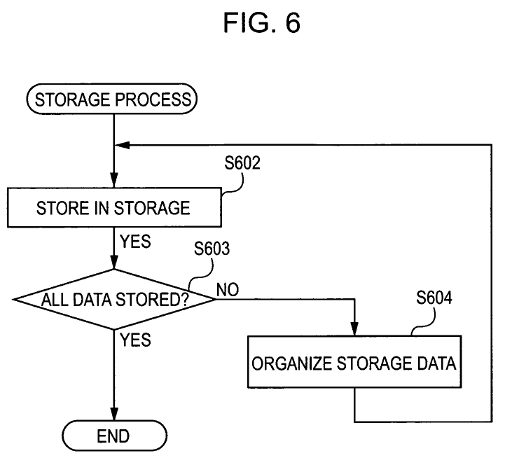

FIG. 6 is a flow chart showing exemplary details of the storage process (S306). Since the printing apparatus 110 does not include a storage, the storage process is not carried out in the printing apparatus 110 upon receipt of a storage request.

The print control unit 221 creates a file at the location in the HDD 124 written in the storage location field 904, wherein the file has the file name written in the file name field 905 in the packet shown in FIG. 9. The data type field 906 and the data length field 907 are stored in the header and the body, respectively, of the file (S602). Then, the print control unit 221 determines whether the entire data set is stored (S603). If the entire data set is stored, the process is ended. If there is not enough storage space to store the entire data set, the data stored in the HDD 124 is organized to create storage space (S604), and then the process is returned to Step S602 to continue the storage process.

[Exemplary Method of Creating Storage Space]

The following exemplary methods may be carried out to organize data so as to create storage space:

(1) intermediate data and image data are indiscriminately stored until a predetermined amount of data is stored, and once the predetermined amount of data is stored, old data (i.e., data having an oldest time stamp indicating the time of creation or storage) is deleted to allow new data to be stored;

(2) intermediate data and image data are indiscriminately stored until a predetermined amount of data is stored, and once the predetermined amount of data is stored, the data having the oldest access record (i.e., data having an oldest time stamp indicating time of access) is deleted to allow new data to be stored;

(3) after a predetermined amount of time elapses after the creation or storage of intermediate data and image data, the intermediate data and the image data are deleted;

(4) intermediate data and image data are indiscriminately stored until a predetermined amount of data is stored, and once the predetermined amount of data is stored, the compression rate of the old data is increased; and

(5) intermediate data and image data are indiscriminately stored until a predetermined amount of data is stored, and once the predetermined amount of data is stored, intermediate data whose data amount can be reduced by converting the intermediate data into image data are searched and rendered into image data to be stored again.

Furthermore, when data is deleted or compressed, the data is processed per document, and files having the same document ID are deleted or compressed at once.

In this way, the printing system according to this embodiment carries out printing by assigning the printing apparatus 110 or the multi-function apparatus 120 from the host PC 101 or another host PC connected to the network 199. At this time, the assigned apparatus carries out printing while, at the same time, intermediate language data or image data acquired by processing the PDL data is stored in a storage and storage information indicating the storage location of the data is added to the image data that is being printed. The storage is not limited to the HDD 124 of the multi-function apparatus 120 and any storage included in a device connected to the network 199 may be used. If software for performing the process shown in the flow chart in FIG. 3, excluding the printing process (S304), is installed in the host PC, the HDD of the host PC may also be used as a storage for storing the intermediate language data or image data.

[Exemplary Copying Process]

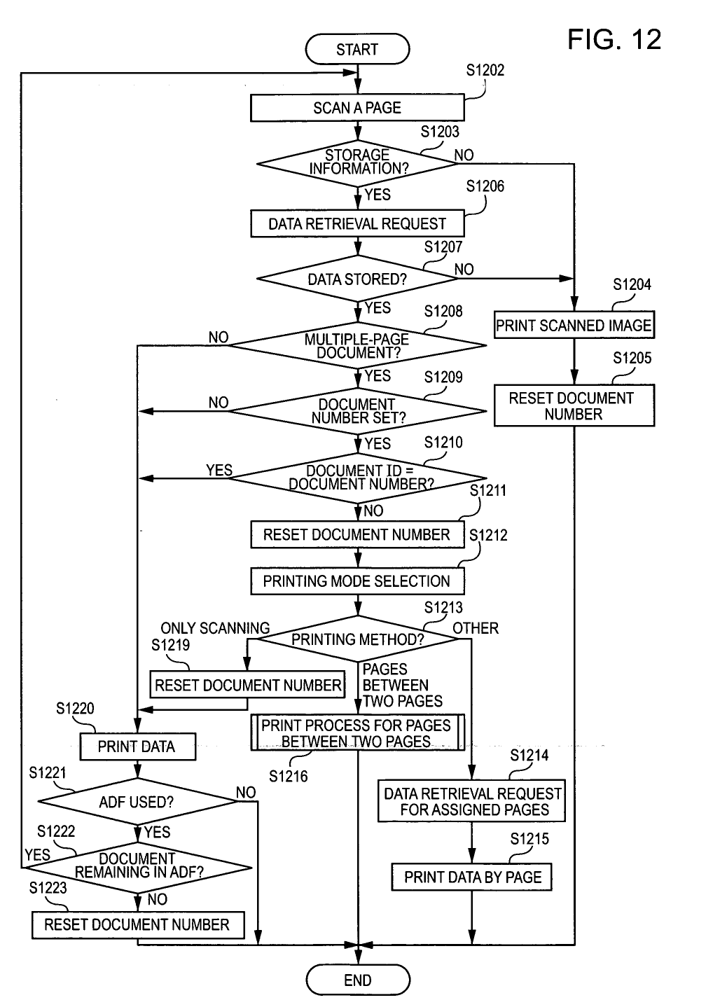

FIG. 12 is a flow chart showing a copying process carried out by the print control unit 221 of the multi-function apparatus 120. This process is carried out when the user sets a document on the document table or the ADF of the scanner 127 of the multi-function apparatus 120 and then inputs an instruction for copying at the operation panel 121. The process is not limited to the multi-function apparatus 120, and any digital copy machine connected to the network 199 may carry out this process.

First, one page of a document is scanned (S1202). Then, it is determined whether storage information is attached to the scanned image (S1203). If storage information is not attached, the scanned image is printed by the printer engine 125 as a regular copy (S1204). After printing, the document number, which is an internal variable of the print control unit 221, is reset (S1205) and then the process ends. As described below, the document ID extracted from the storage information included in the scanned image is set in the document number, which is an internal variable.

When storage information is attached to the scanned image, data is retrieved on the basis of the storage information (S1206). FIG. 10 illustrates an exemplary packet for a retrieval request. A code corresponding to an address of a device providing the storage for the storage information is written in a destination address field 1001, a code corresponding to an address of the apparatus sending out the request is written in a source address field 1002, and a code corresponding to ‘data retrieval request’ is written in a command field 1003. Furthermore, codes corresponding to the storage location and the file name for the file indicated by the storage information are written in a storage location field 1004 and a file name field 1005, respectively.

FIG. 11 illustrates an exemplary packet sent back from the device that received the data retrieval request. A code corresponding to the address of the apparatus that has sent out a data retrieval request (which, in this case, is the multi-function apparatus 120) is written in a destination address field 1101, a code corresponding to the address of the device that has received the data retrieval request is written in a source address field 1102, and a code corresponding to a ‘retrieval result’ is written in a command field 1103. Furthermore, codes corresponding to the storage location, the file name, and the data type are written in a storage location field 1104, a file name field 1105, and a data type field 1106, respectively. The actual data is included in a data field 1107. If the data requested to be retrieved is already deleted, the fields 1106 and 1107 are set as ‘null.’ A code corresponding to the number of files (i.e., the number of pages of the document) having the same document ID as the file requested to be retrieved is written in a file number field 1108.

Referring back to FIG. 12, after the data retrieval request (S1206), then it is determined, on the basis of the fields 1106 and 1107 in the received packet, whether intermediate language data or image data is stored (S1207). If data is not stored, the scanned image is printed by the printer engine 125 as a regular copy (S1204), and the document number, which is an internal variable, is reset (S1205).

If intermediate language data or image data is stored, the file number field 1108 is referred to to determine whether the scanned page is a page of a document including other pages (S1208). Then, it is determined whether a value is set for the document number (S1209). Then, it is determined whether the document number matches the document ID included in the file name in the storage information attached to the scanned image (S1210). Subsequently, if the result of Step S1208 or S1209 is ‘no’ or if the result of Step S1210 is ‘yes,’ the process proceeds to Step S1220.

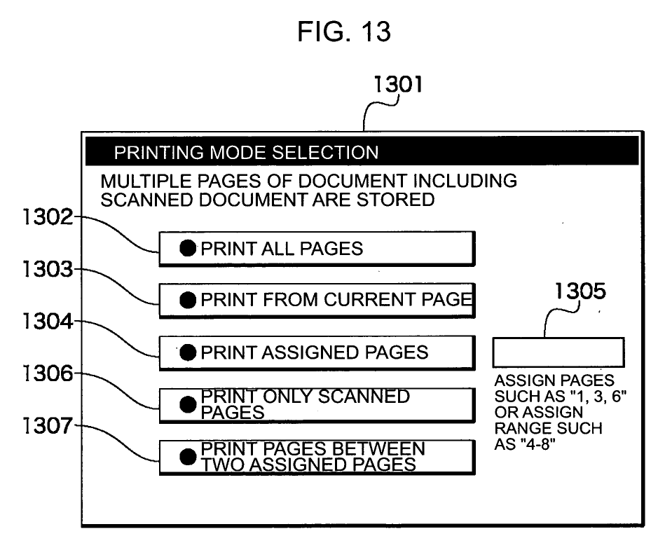

If the results of Steps S1208 and S1209 are ‘yes’ and the result of Step S1210 is ‘no,’ the document number is reset (S1211), and an operation screen 1301, as shown in FIG. 13, is displayed on the operation panel 121 (S1212). In this way, the user is informed that data including other pages of the document of the scanned page is stored in a storage connected to the network 199 and is requested to select the printing mode.

The user selects the printing mode by pressing one of the following buttons: a ‘print all pages’ button 1302 for printing all pages of the document; a ‘print from current page’ button 1303 for printing the scanned page and the subsequent pages; and a ‘print assigned page’ button 1304 for printing the assigned page(s); and, a ‘print scanned page only’ button 1306 for printing only the page that has been scanned. The user may also select a ‘print pages between assigned pages’ button 1307 for printing the pages of the document interposed between the two scanned pages. When the ‘print assigned page’ button 1304 is selected, a page or a range of pages is assigned by inputting the page number in an input box 1305.

Referring again to FIG. 12, next, it is determined which printing mode has been selected by the user (S1213). If the button 1302, 1303, or 1304 is selected, a data retrieval request is carried out by assigning the page(s) of the document to be retrieved (S1214). If the ‘print all pages’ button 1302 is selected, all pages, except for the pages already retrieved in Step S1206, are assigned. If the ‘print from current page’ button 1303 is selected, the pages after the pages that already have been retrieved are assigned. If the ‘print assigned page’ button 1304 is selected, the page or the range of pages assigned at the input box 1305, except for the pages that already have been retrieved, are assigned.

The intermediate language data or the image data obtained by the retrieval request sent out in Step S1206 and/or S1214 are printed in order by page (S1215). If it is determined, on the basis of the information included in the data type field 1106 of the packed shown in FIG. 11, that the data included in the data field 1107 is image data, the data is directly sent to the printer engine 125. If the data is intermediate language data, the data is rendered by the renderer 225, and the image data obtained after rendering is sent to the printer engine 125 for printing. In this case as well, the storage information indicating the storage location of the intermediate language data or the image data is attached to the image data, and then the image data is printed out.

If the ‘print scanned page only’ button 1306 is selected, the document ID included in the file name obtained by the retrieval request sent out in Step S1206 is set in the document number, which is an internal variable (S1219). Then, the process proceeds to Step S1220.

If it is determined in Steps S1208, S1209, and S1210 that the printing mode does not have to be selected or if the user selects the ‘print scanned page only’ button 1306, an image based on the data retrieved as a result of the retrieval request sent out in Step S1206 is printed (S1220). If it is determined, on the basis of the information included in the data type field 1106 of the packed shown in FIG. 11, that the data included in the data field 1107 is image data, the data is directly sent to the printer engine 125. If the data is intermediate language data, the data is rendered by the renderer 225, and the image data obtained after rendering is sent to the printer engine 125 for printing. In this case as well, storage information indicating the storage location of the intermediate language data or the image data is attached to the image data, and then the image data is printed out.

Then, it is determined whether scanning has been performed using the ADF (S1221). If the ADF is used, it is determined whether more pages of the document remain in the ADF (S1222). If there are more pages in the ADF, the process is returned to Step S1202 and the subsequent steps are repeated since the remaining pages may not be pages from the same document.

If the document ID attached to the page newly read in Step S1202 matches the document number set in Step S1219, and it is determined in Step S1210 that a printing mode does not have to be selected, then process proceeds to S1220. These steps are carried out to prevent the same processing from being carried out twice on the same document.

After S1222, if pages of the document do not remain in the ADF, the document number, which is an internal variable, is reset (S1223), and the process is ended. If the ADF is not used (i.e., if the document is place on the document table), the process is ended. If the process is ended because the ADF is not used, the document number is not reset because the pages of the document may be copied using the document table. However, if the printing process is not restarted after a predetermined amount of time, the document number is reset. The user can reset the document number by operating the operation panel 121.

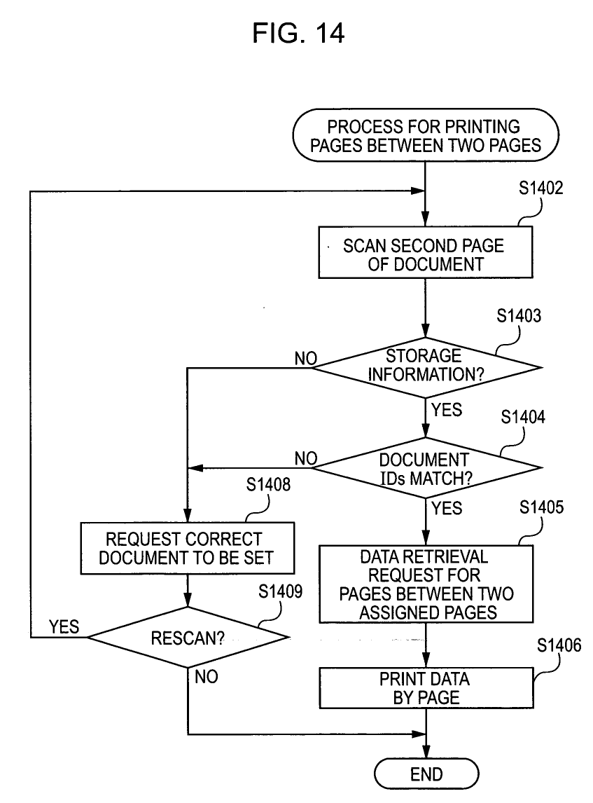

If the ‘print pages between assigned pages’ button 1307 is selected, the process for printing the pages between two predetermined pages (S1216) is carried out. FIG. 14 is a flow chart showing an exemplary process for printing pages between two predetermined pages. In the process for printing pages between two predetermined pages, two predetermined pages of the document are scanned (S14O2). At this time, if the first page is scanned using the ADF, the second page is also scanned using the ADF. However, if the first page is scanned using the document table, an instruction for setting the second page on the document table is displayed the operation panel 121. Then, the second page is scanned after the start button on the operation panel 121 is pressed.

Then, it is determined whether storage information is attached to the scanned image of the second page (S1403). The document ID included in the file name of the storage information attached to the scanned second page is extracted and determined whether it matches the document ID of the first scanned image (S1404). If storage information is not attached to the second scanned image or if the document IDs of the first and second pages do not match, the operation panel 121 displays a message informing the user that storage information is not included in the second image or that the two images have difference document IDs. Further, the operation panel 121 may display a request for the correct document to be set (S1408). In this way, the user can set the correct page of the document. Then, if the user presses the start button on the operation panel 121, the process is returned to Step S1402 to rescan the second page of the document (S1409). If the cancel button on the operation panel 121 is pressed, the printing process is ended.

If storage information is attached to the second scanned image and the document IDs of the first and second images match, data retrieval is requested on the basis of the storage information attached to the first and second images (S1405). At this time, the page numbers included in the file names of the first and second pages are compared and the data retrieval is requested in order, for example, by page. If the printing is set in a reversed order, a data retrieval request for retrieving the pages in the inverse order is sent out. Since the data corresponding to the first scanned page has already been obtained in Step S1206, data retrieval does not have to be requested for the first page.

Next, the pages of the intermediate language data or the image data obtained by the retrieval request sent out in Steps S1206 and S405 are printed by page (S1406). If it is determined, on the basis of the information included in the data type field 1106 of the packed shown in FIG. 11, that the data included in the data field 1107 is image data, the data is directly sent to the printer engine 125. If the data is intermediate language data, the data is rendered by the renderer 225, and the image data obtained after rendering is sent to the printer engine 125 for printing. In this case as well, storage information indicating the storage location of the intermediate language data or the image data is attached to the image data, and then the image data is printed out.

[Exemplary Data Retrieval Process]

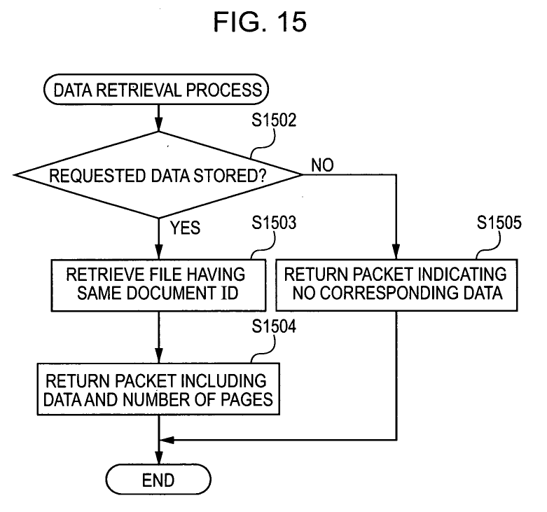

FIG. 15 is a flow chart showing an exemplary data retrieval process (S307) that is carried out by the print control unit 221 of the multi-function apparatus 120. Here, it is noted that the printing apparatus 110 does not receive a data retrieval request since it does not include a storage.

When a data retrieval request is received, it is determined whether files corresponding to the storage location field 1004 and the file name field 1005 of the packet shown in FIG. 10 exist (S1502). If files exist, files having the same document ID as the document ID included in the file name written in the file name field 1005 are searched for (S1503). The number of detected files is written in a document page number field 1108 of the packet shown in FIG. 11. Then, a packet including the intermediate language data or the image data in the data field 1107 is sent back (S1504). If files do not exist, the data type field 1106 and the data field 1107 of the packet, shown in FIG. 11, are set as ‘null,’ and then the packet is sent back (S1505).

In this way, if a page of a document including storage information is scanned in the copying process, it is. determined whether the electronic data corresponding to the page is stored in a storage and whether the scanned page is a page of a document including other pages. If electronic data corresponding to the page is stored in a storage and if the scanned page is a page of a document including other pages, the uses is instructed to select one of the printing modes, ‘print all pages of the document,’ ‘print the scanned page and the subsequent pages,’ ‘print assigned pages,’ ‘print the scanned page only,’ or ‘print pages between first and second assigned pages.’ Accordingly, pages that have not been scanned can be printed if the electronic data of the unscanned pages of the document is stored and if the user requests the printing.

If the user loads a plurality of pages of the document in the ADF and selects the ‘print the scanned page only’ mode, the printing mode of the remaining pages is not reconfirmed. Hence, the user may not be bothered with unnecessary operations. If the ‘print the scanned page only’ mode is selected when the user places a page of a document on the document table to carry out copying, the printing method is not reconfirmed even if second page of the document is scanned after the first page. Thus, in this case too, the user may not be bothered with unnecessary operations.

In the above embodiment, the file name of the file generated by the print control unit 211 (221) was “apparatus ID_document ID_page number.” In an alternative embodiment, a directory or a folder named “apparatus ID_document ID” may be created and files each named “page number” may be created in the directory or the folder to achieve the same advantages as described above.

In such a case, in the process in Step S404 (see FIG. 4), if a directory name “apparatus ID_document ID” is not stored in the storage of the apparatus, the directory is created and intermediate language data or image data is stored in this directory as files each named “page number.” While in Step S412 (see FIG. 4), a directory named “apparatus ID_document ID” is created in the storage assigned in the storage location field 904 of the packet shown in FIG. 9. In Step S602 (see FIG. 6), if the directly assigned in the storage location field 904 does not exist, the directory is created. Then, a file having the name written in file name field 905 is created in the directory. In Step S1503 (see FIG. 15), the number of pages of the document is set based on the number of files included in the directory that is assigned by the storage location field 1004 of the packet shown in FIG. 10.

The methods for assigning the pages to be printed is not limited to the methods described above, various modifications are possible such as providing a printing mode, ‘print pages preceding current page.’

### Second Exemplary Embodiment

A printing system according to a second embodiment of the present invention is described below. The components according to the second embodiment that are the same as those according to the first embodiment are represented by the same reference numerals, and descriptions thereof are omitted.

According to the first embodiment, in the copying process of the multi-function apparatus 120, when a first page of a document having storage information is scanned, it is determined whether electronic data of the page is stored in a storage and whether the scanned page is a page of a document including other pages. As a result, if the page is a page of a document including other pages, the user is instructed to select a printing mode. However, the same advantages as described above may be achieved even when the user selects the printing mode before starting the copying process.

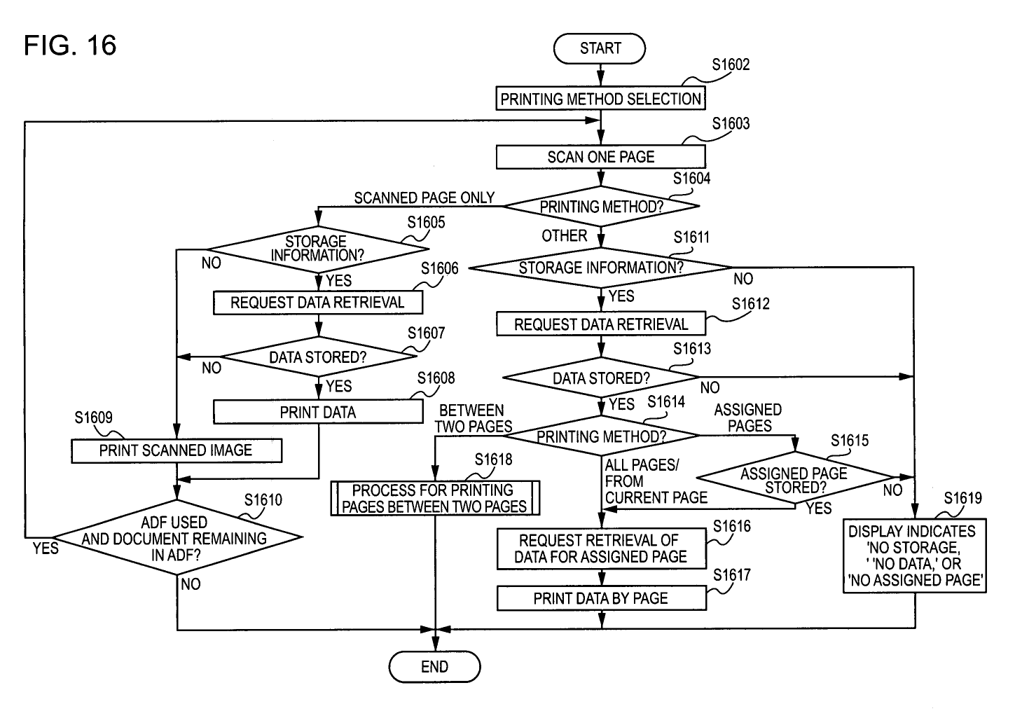

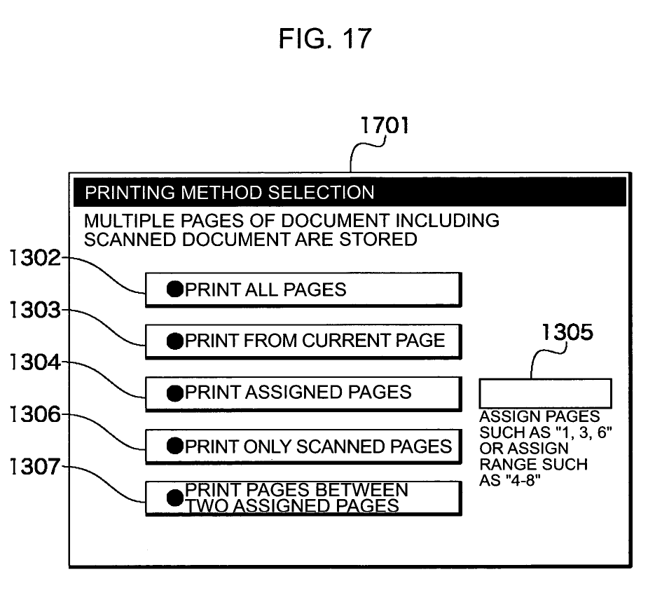

FIG. 16 is a flow chart showing an exemplary process for the user to select a printing mode before the copying process is started. When the user selects a copy mode by operating the operation panel 121, an operation screen 1701, shown in FIG. 17, is displayed on the operation panel 121 (S1602) and instructs the user to select the printing mode. Buttons, shown in FIG. 17, for selecting the printing mode are similar as those shown in FIG. 13, and descriptions thereof are omitted.

When the user selects a printing mode and presses the start button corresponding to the printing mode on the operation panel 121, a page of a document is scanned (S1603) and the selected printing mode is determined (S1604).

If the ‘print only scanned page’ button 1306 is selected, it is determined whether storage information is attached to the image obtained by scanning a page of a document (S1605). If storage information is not attached to the scanned image, the scanned image is printed by the printer engine 125 as a regular copy (S1609). If storage information is attached, a data retrieval request is sent out on the basis of the storage information (S1606). Then, it is determined, on the basis of the fields 1106 and 1107 of the packet received in response, whether intermediate language data or image data is stored (S1607). If it is determined that data is not stored, the scanned image is printed by the printer engine 125 as a regular copy (S1609).

When it is determined that intermediate language data or image data is stored, the data is printed out (S1608). If it is determined that the data included in the data field 1107 is image data on the basis of the information included in the data type field 1106 of the packet shown in FIG. 11, the data is directly sent to the printer engine 125. If the data is intermediate language data, the data is rendered by the renderer 225, and the image data obtained after rendering is sent to the printer engine 125 for printing. In this case as well, storage information indicating the storage location of the intermediate language data or the image data is attached to the image data, and then the image data is printed out.

Then, it is determined whether the ADF is used and whether any pages remain in the ADF (S1610). If pages remain in the ADF, the process is returned to Step S1603 and the subsequent steps are repeated. If the ADF is not used or if no pages remain in the ADF, the process is ended. The printing mode is not changed for the next copying process unless the user selects a different printing mode.

If a printing mode other than that selected by pressing the ‘print only scanned page’ button 1306 is selected, it is determined whether storage information is attached to the image of the scanned page (S1611). If storage information is not attached to the scanned image, the operation panel 121 indicates that storage information is not attached to the scanned image (S1619), and the process is ended.

If storage information is attached to the scanned image, a data retrieval request based on the storage information is sent out (S1612). Then, it is determined, on the basis of the fields 1106 and 1107 of the packet received in response, whether intermediate language data or image data is stored (S1613). If data is not stored, the operation panel 121 displays a message indicating that data of the document is not stored (S1619), and the process is ended.

If intermediate language data or image data is stored, the selected printing mode is determined again (S1614). If the printing mode for printing the pages between two pages is selected, the process for printing the pages between predetermined pages, shown in FIG. 14, is carried out (S1618).

When the printing mode for printing assigned pages is selected, it is determined whether the pages input in the input box 1305 exist in the document of the scanned image (S1615). In other words, the page number in the file number field 1108 of the packet shown in FIG. 11 is compared with the page numbers assigned in the input box 1305, and if the page number in the file number field 1108 is smaller than the pages numbers assigned in the input box 1305, the operation panel 121 displays a message indicating that the assigned pages do not exist (S1619). Then, the process is ended.

In step S1614, the printing mode selected in Step S1602 is determined. If it is determined in Step S1614 that a printing mode for printing assigned pages has been selected, the process proceeds to Step S1615. In Step S1615, it is determined whether the assigned pages are stored. When it is determined that the assigned pages exist or when the printing mode for printing all pages of the document or printing the scanned page and the subsequent pages is selected, a data retrieval request for the assigned pages of the document is sent out (S1616). When the printing mode for printing all pages is selected, all pages are assigned to be retrieved, except for the pages already retrieved in Step S1612. When the printing mode for printing the scanned page and the subsequent pages is selected, the pages subsequent to the pages that have already been retrieved are assigned. If the printing mode for printing assigned pages is selected, the page or range of pages input in the input box 1305, except for the pages that have already been retrieved, are assigned.

Then, the intermediate language data or the image data of the pages obtained as a result of the retrieval request sent out in Step S1612 and/or Step S1616 are printed (S1617). If it is determined that the data included in the data field 1107 is image data on the basis of the information included in the data type field 1106 of the packed shown in FIG. 11, the data is directly sent to the printer engine 125. If the data is intermediate language data, the data is rendered by the renderer 225, and the image data obtained after rendering is sent to the printer engine 125 for printing. In this case as well, storage information indicating the storage location of the intermediate language data or the image data is attached to the image data, and then the image data is printed out.

### Variation of Second Embodiment

In the above-described embodiment, the storage information may be information conforming to a known uniform resource locator (URL) format indicating the network path to the address of the device storing the electronic data and file name.

In the above, intermediate language data and image data were the exemplary data to be retrieved. However, the type of data is not limited, and application data generated by application software or the application data converted into a PDL data format by the printer driver may be may be retrieved as well.

For application data, after the data is retrieved, the data is converted into a printing data format by a predetermined printer driver installed in the server. Then, printable image data is generated from this printing data and printed out. For PDL data, printable image data is generated from PDL data obtained by a printing apparatus capable of interpreting the PDL data.

### Other Exemplary Embodiments

Embodiments of the present invention may be employed in a system constituting a plurality of device (for example, a host computer, an interface device, a reader, and a printer) or may be employed in a single apparatus (for example, a multi-function apparatus or a facsimile apparatus).

The various processing units according to the above-described embodiments can be realized by providing a recording medium storing program codes for software capable of realizing the functions according to the above-described embodiments to the system or the apparatus. A computer (central processing unit (CPU) or micro processing unit (MPU)) included in the system or the apparatus reads out the program codes stored on the storage medium and carries out above-described process entirely or partially. In such a case, the program codes read out from the recording medium realize the functions according to the above-described embodiments. Therefore, the recording medium storing the program codes constitutes an aspect of the present invention. Further, embodiments of the present invention are not limited to executing the program codes read out by a computer. Another embodiment of the present invention may be realized by entirely or partially carrying out the actual processing by an operation system (OS) operating on the computer in accordance with the program codes to perform the functions of the above-described embodiments.

Other embodiments of the present invention include the steps of realizing the functions according to the above-described embodiments by executing the program codes read out from the recording medium and written in a function expansion board mounted in the computer or a function expansion unit connected to the computer. More specifically, an embodiment of the present invention may be realized by entirely or partially carrying out the actual processing by a CPU included in the function expansion board or the function expansion unit in accordance with the program codes.

When embodiments of the present invention are employed in the above-described recording medium, program codes corresponding to the above-described flow charts are stored on the recording medium.

As described above, a system according to the various embodiment is capable of efficiently using electronic data corresponding to an image of a document stored in a storage by easy operation.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2004-364780 filed Dec. 16, 2004, which is hereby incorporated by reference herein in its entirety.

What is claimed is:

1. An image processing apparatus comprising:
a reading unit adapted to read at least a page of a document and to generate image data corresponding to the read page;
a detecting unit adapted to detect specifying information included in the image data obtained by the reading unit, the specifying information including information on electronic data corresponding to the document read by the reading unit;
a searching unit adapted to retrieve the electronic data from a storage on the basis of the specifying information detected by the detecting unit;
a setting unit adapted to set a printing mode of the electronic data retrieved by the searching unit when the page read by the reading unit corresponds to a portion of the document corresponding to the retrieved electronic data; and
a printing unit adapted to print out an image of the retrieved electronic data in accordance with the printing mode set by the setting unit.

2. The apparatus according to claim 1, wherein the setting unit sets the printing mode such that all pages of document corresponding to the retrieved electronic data are printed out by the printing unit regardless of the number of pages read by the reading unit.

3. The apparatus according to claim 1, wherein the setting unit sets the printing mode such that a page of the electronic data corresponding to a page of the document read by the reading unit is printed out by the printing unit.

4. The apparatus according to Clam 1, wherein the setting unit sets the printing mode such that two pages and pages interposed between these two pages of the electronic data are printed out by the printing unit, the two pages corresponding to two pages of the document read by the reading unit.

5. The apparatus according to claim 1, wherein the setting unit sets the printing mode such that a range of the electronic data defined by pages of the document read by the reading unit is printed out by the printing unit.

6. An image processing method comprising:
reading at least a page of a document and generating image data corresponding to the read page;
detecting specifying information included in the image data, wherein the specifying information includes information on electronic data corresponding to the document read;
retrieving the electronic data from a storage on the basis of the specifying information;
setting a printing mode of the retrieved electronic data when the page read corresponds to a portion of the document corresponding to the retrieved electronic data; and
printing out an image of the retrieved electronic data in accordance with the set printing mode.

7. A computer readable program stored in a storage medium comprising:
computer-executable instructions for reading at least one page of a document and to generate image data corresponding to the read page;
computer-executable instructions for detecting specifying information included in the image data, the specifying information including information on electronic data corresponding to the at least one read page of the document;
computer-executable instructions for retrieving the electronic data from a storage on the basis of the specifying information;
computer-executable instructions for setting a printing mode of the electronic data when the at least one read page corresponds to a portion of the document corresponding to the retrieved electronic data; and
computer-executable instructions for printing out an image of the retrieved electronic data in accordance with the set printing mode.
